(19) United States
(12) Patent Application Publication
(10) Pub. No.: US 2012/0246552 A1
(43) Pub. Date: Sep. 27, 2012

(54) PROVIDING A PARTICULAR TYPE OF UNIFORM RESOURCE LOCATOR

(76) Inventors: Samson J. Liu, Mountain View, CA (US); Suk Hwan Lim, Mountain View, CA (US); Jerry J. Liu, Sunnyvale, CA (US)

(21) Appl. No.: 13/052,622

(22) Filed: Mar. 21, 2011

(51) Int. Cl. G06F 17/00

(52) U.S. Cl. 715/234

(57) ABSTRACT

Examples disclosed herein are example systems and methods to provide a particular type of uniform resource locator. In one example, a processor identifies webpage source code associated with a list of text associated with the type of uniform resource locator. The processor may identify a uniform resource locator within the identified webpage source code and provide the uniform resource locator.

### BACKGROUND

A webpage may include hyperlinks to other webpages, for example, to a printer friendly version of the webpage. The printer friendly version may include text without additional graphics and other information tailored to webpage display. In some cases, it may be desirable to locate a printer friendly version of a webpage, such as to run automated information retrieval algorithms or to archive a webpage. A user may manually review a webpage to determine if it contains a link to a printer friendly version or other type of webpage.

### BRIEF DESCRIPTION OF THE DRAWINGS

The drawings describe example implementations. The drawings illustrate methods being performed in an example order, but the methods may also be performed in other orders. The following detailed description references the drawings, wherein:

FIG. 1 is a block diagram illustrating one example of a computing system

FIGS. 2 and 3 are flow charts illustrating examples of methods to provide a uniform resource locator.

FIG. 4 is a flow chart illustrating one example of a method to identify a portion of a webpage indicating a particular type of uniform resource locator.

FIG. 5 is a flow chart illustrating one example of a method to extract a uniform resource locator from a webpage.

FIG. 6 is a flow chart illustrating one example of method to compare a portion of a webpage to keywords related to multiple languages.

### DETAILED DESCRIPTION

In one example, a particular type of uniform resource locator (URL) may be identified from a webpage's source code and extracted. For example, a processor may evaluate webpage source code to automatically locate a uniform resource locator for a particular type of webpage, such as a uniform resource locator address of a printer friendly version of the webpage. The processor may analyze the webpage, source code associated with uniform resource locators. For example, the processor may search for text displayed on a text link for a user to click to navigate to a webpage at the associated uniform resource locator. The webpage, source code may be compared to keywords related to a particular type of uniform resource locator link. For example, text displayed for a link to a webpage at a uniform resource locator may be compared to a list of keywords, such as phrases “print version” or “printer friendly” likely to indicate a uniform resource locator associated with a printer friendly version of the webpage. The uniform resource locator associated with the text may be extracted. In some implementations, the uniform resource locator may be further processed to determine whether it is valid. Automatically detecting a uniform resource locator of a particular type of webpage may allow for information retrieval algorithms, archival algorithms, or other webpage processing algorithms to better navigate through webpages to access particular types of webpage links.

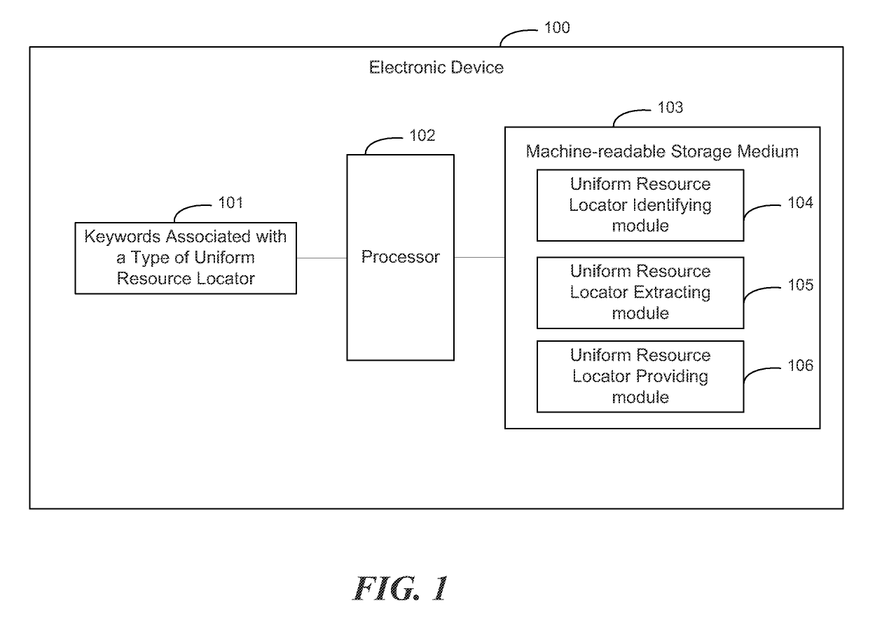

FIG. 1 is a block diagram illustrating one example of a computing system 100. The computing system 100 may include, for example, a processor 102, a machine-readable storage medium 103, and keywords 101 associated with a type of uniform resource locator. The keywords 101 may be stored, for example, in a volatile or non-volatile storage. In some cases, the keywords 101 are stored in the machine-readable storage medium 103. The keywords 101 may be any suitable keywords associated with a type of uniform resource locator. For example, the keywords 101 may be a dictionary or table of words or phrases determined to be likely to be included in webpage code associated with a uniform resource locator link of a particular type. The keywords 101 may be, for example, words related to text or images displayed for a uniform resource locator link of a particular type.

The processor 102 may be any suitable processor, such as a central processing unit (CPU), a semiconductor-based microprocessor, or any other device suitable for retrieval and execution of computer-readable instructions, In one implementation, the electronic device 100 includes logic instead of or in addition to the processor 102. As an alternative or in addition to fetching, decoding, and executing instructions, the processor 102 may include one or more integrated circuits (ICs) or other electronic circuits that comprise a plurality of electronic components for performing the functionality described below. In one implementation, the electronic device 100 includes multiple processors. For example, one processor may perform some functionality and another processor may perform other functionality.

The machine-readable storage medium 103 may be any suitable machine readable medium, such as an electronic, magnetic, optical, or other physical storage device that stores executable instructions or other data (e.g., a hard disk drive, random access memory (RAM), flash memory, storage disk(s) disk array(s), tape drive(s), volatile and/or non-volatile memory, compact disc(s) (CD), digital versatile disc(s) (DVD), floppy disk(s), read-only memory (ROM), programmable ROM (PROM), electronically-programmable ROM (EPROM), electronically-erasable PROM (EEPROM), optical storage disk(s), optical storage device(s), magnetic storage disk(s), magnetic storage device(s), cache(s), and/or any other physical storage device in which data is stored for any duration). The machine-readable storage medium 103 may be, for example, a computer readable non-transitory medium. The machine-readable storage medium 103 may include modules with instructions executable by the processor 102, For example, the machine-readable storage medium 103 may include a uniform resource locator identifying module 104, a uniform resource locator extracting module 105, and a uniform resource locator providing module 106, The uniform resource locator identifying module 104 may include instructions executable by the processor 102 to compare webpage source code to the keywords 101 to identify a portion of the webpage source code likely to contain a uniform resource locator of a particular type. The uniform resource locator extracting module 105 may include instructions executable by the processor 102 to extract a uniform resource locator from the identified portion of the webpage source code, The uniform resource locator providing module 106 may include instructions to provide the extracted uniform resource locator, such as by storing, transmitting, or displaying the uniform resource locator.

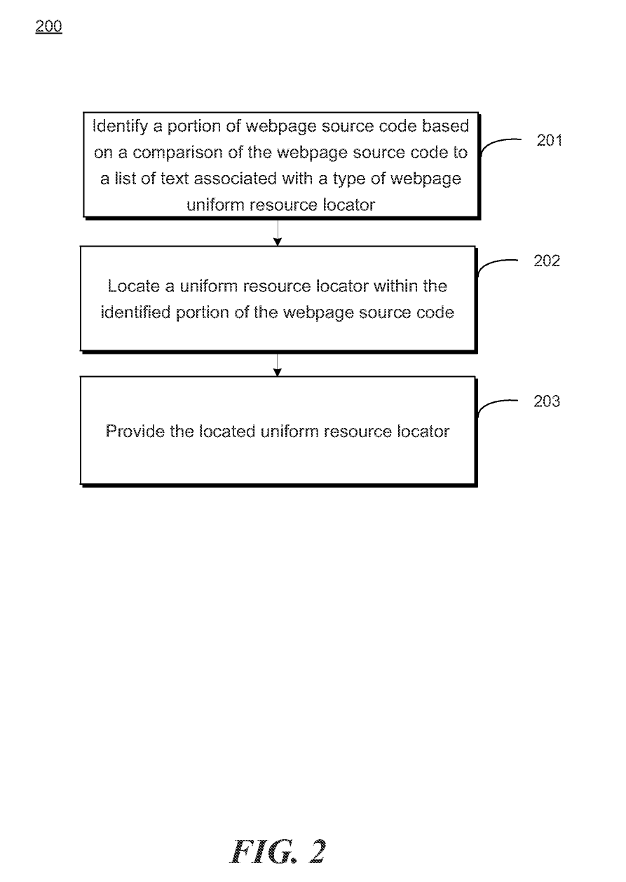

FIG. 2 is a flow chart 200 illustrating one example of a method to provide a uniform resource locator from a webpage. For example, a processor may search for a particular type of uniform resource locator on a webpage, such as a uniform resource locator linking to a particular type of page, and provide the located uniform resource locator. The processor may locate the uniform resource locator by comparing the source code on the webpage to a table of keywords determined to be likely to be associated with a particular type of uniform resource locator. In one example, the method is performed by the electronic device 100.

Beginning at 201, a processor identifies a portion of webpage source code based on a comparison of the webpage source code to a list of text associated with a type of webpage uniform resource locator, The processor may compare any suitable portion of the webpage source code to the list of text. In some cases, the processor may search the webpage source code for words or phrases found in the list of text associate with the type of uniform resource locator. The processor may identify a portion of the webpage associated with words or phrases located on the webpage that are found in the list of text.

Continuing to 202, the processor locates a uniform resource locator within the identified portion of the webpage source code. For example, the processor may look for characters indicating a uniform resource locator within the identified portion of the webpage. in some cases, the processor may perform validity checks on a located uniform resource locator.

Proceeding to 203, the processor provides the located uniform resource locator. For example, the processor may display, store, or transmit the uniform resource locator. In some cases, the processor accesses the webpage located at the uniform resource locator.

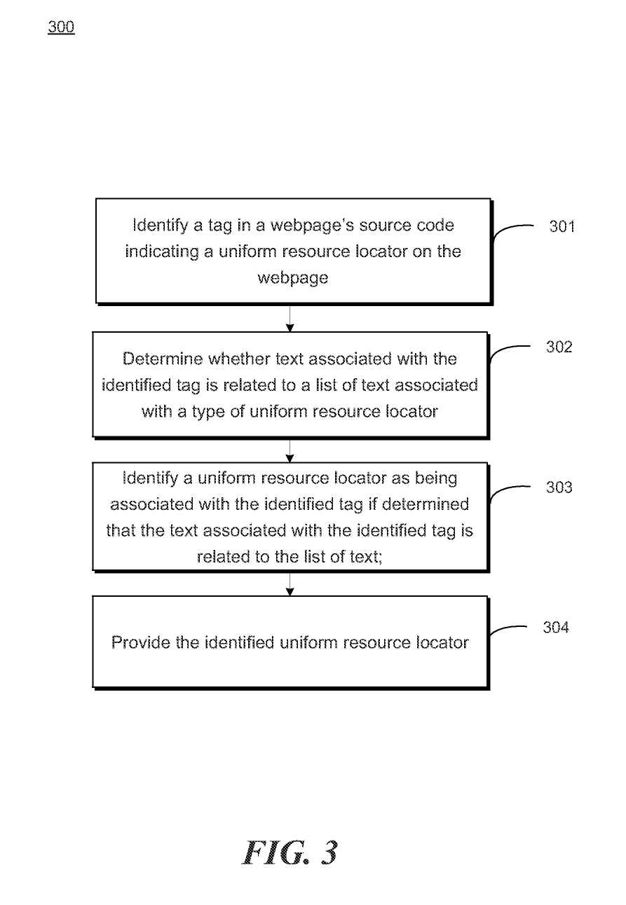

FIG. 3 is a flow chart 300 illustrating one example of a method to provide a uniform resource locator from a webpage. For example, a uniform resource locator of a particular type may be identified within webpage source code by comparing webpage source code associated with a uniform resource locator to a list of text likely to be associated with a particular type of uniform resource locator. If the evaluated portion of the webpage source code correlates to the list of text, the uniform resource locator may be extracted from the webpage source code. Extracting the uniform resource locator may involve some processing to determine the validity of the uniform resource locator. Then, the extracted uniform resource locator may be provided. The method may be performed by any suitable electronic device, such as by the electronic device 100.

Beginning at 301, a processor identifies a tag in a webpage's source code indicating a uniform resource locator on the webpage. The processor may be any suitable process, such as a Central Processing Unit (CPU). In one implementation, the processor is the processor 102.

The tag may be any suitable hyperlink tag, such as a tag associated with Hypertext Markup Language (HTML) or other webpage description languages. HTML and other tag based markup languages, such as Extensible Markup Language (XML), may include a tree structure of tags with information between tags where each beginning tag has a corresponding ending tag. The beginning tag may appear with a tag identifier between brackets < >. For example, a tag to begin a table may be <table>. An ending tag may appear with a tag identifier and a front slash. For example, a tag to end a table may be </table>.

The processor may evaluate the webpage source code to search for any suitable tag indicating a uniform resource locator. For example, an <a> tag may indicate a link. An example <a href=www.test.com>Test</a> may indicate a link with the text “Test” displayed on the webpage where the link routes to the webpage located at the uniform resource locator www.test.com. The processor may search, for example, to locate an <a> tag within the webpage source code.

The processor may search for the type tag, for example, by comparing the text in the webpage source code to a list of tags. In some implementations, the processor may search a tree structure of tags on the webpage. For example, a document object model (DOM) tree may have a tree structure representing the tags on the webpage. A tree structure may be limited to actual tags on the webpage. Using a tree structure may be beneficial because a hyperlink tag could be, for example, included in a comment or other text not representing an actual tag. In addition, in some cases, a search through a tag structure may be more efficient that searching through the webpage source code text.

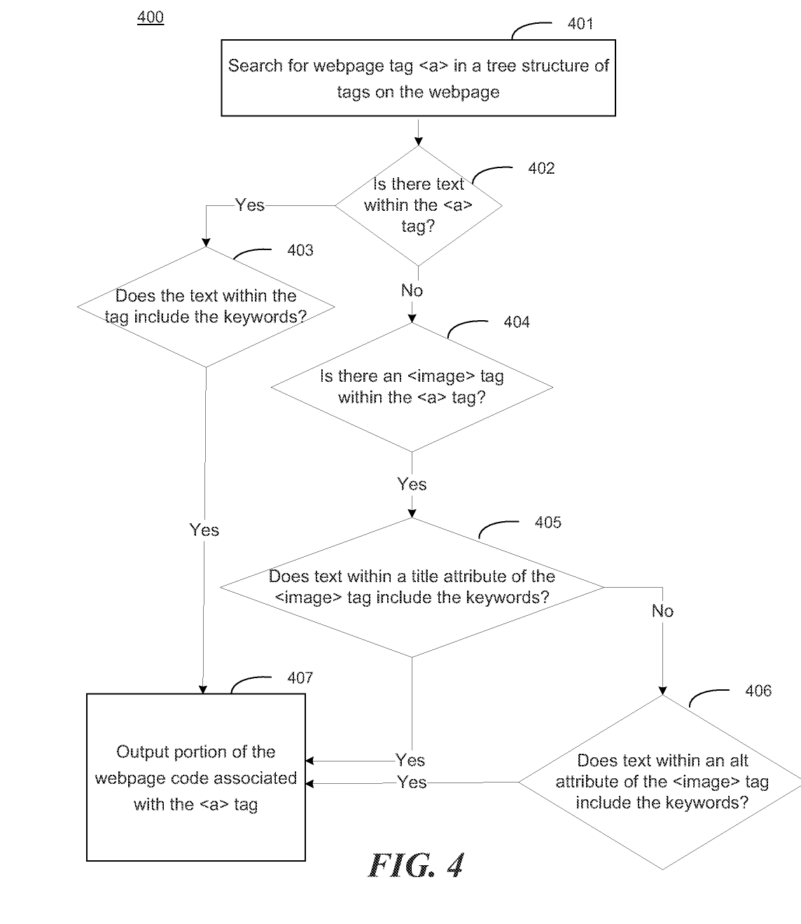

The flow chart 300 is discussed in conjunction with FIG. 4. FIG. 4 is a flow chart 400 illustrating one example of a method to identify a portion of a webpage indicating a particular type of uniform resource locator. At 401, the processor may search the webpage source code for an <a> tag indicating a reference, such as a link. The processor may do a text search of the webpage source code or search for the tag in a tree structure of webpage tags.

Referring back to FIG. 3 and continuing to 302, the processor determines whether text associated with the identified tag is related to a list of text associated with a type of uniform resource locator. The text may be associated with the identified tag in any suitable manner. For example, the text may be text displayed on the webpage. For example, <a href=www.computer.com> Computer </a> may be a link with “Computer” displayed, and “Computer” may be compared to the list of text. In some implementations, the text may be associated with attributes of the tag, A tag may have attributes that are not displayed on the webpage. For example, a tag <img title=“computer” src=“computer.jpg” alt=“Computer Link” /> may indicate an image with attributes title, src, and alt. The title of the image may be “computer”, the image displayed may be found at the source “computer.jpg”, and the text “Computer Link” may be displayed as an alternative if the image “computer.jpg” may not be displayed. The processor may compare the attribute values, such as values to the alternative and title attributes, to the list of text.

The list of text associated with a type of uniform resource locator may be a dictionary or table of words or phrases likely to be associated with the uniform resource locator, such as likely to be displayed to link to the webpage located at the uniform resource locator or likely to be in the webpage source code within a tag associated with the uniform resource locator. The list of text may be manually or automatically compiled. The type of uniform resource locator may be any suitable type. As an example, the type of uniform resource locator may be a uniform resource locator for a printer friendly version of a webpage, and the list of text may be “print”, “printer”, and “plain text”, The processor may compare webpage source code associated with the identified tag to the list of text. If the text correlates, such as by including the keywords, the processor may determine that the identified tag is likely to contain the type of uniform resource locator.

Referring back to FIG. 4, at 402, the processor evaluates the text within the <a> tag. For example, the processor may determine whether there is text within the <a> and </a> tags. If the tag does include text to be displayed, such as the text “printer friendly” in the text <a href=www.test.com> printer friendly </a>, at 403 the processor determines whether the text is included in a list of keywords associated with the particular type of uniform resource locator. The text may be compared to the list of keywords in a case sensitive or case insensitive manner. If the text includes the keywords, the processor continues to 407 to output the href attribute value, such as www.test.com in the example.

If no text is included within the <a> tag, at 404 the processor determines whether there is an image tag within the <a> tag, If not, the processor may continue to analyze the next <a> tag within the webpage source code. In some cases, the processor may analyze an image tag even if there is text within the <a> tag, such as if the keywords are not found within the text. If there is an image tag within the <a> tag, at 405 the processor determines whether a title attribute included within the image tag includes the keywords. The title attribute may include the title of the image displayed. A title may in some cases reflect the purpose of the image, For example, for <a href www.test.com><img title=“Printer Friendly” src=“c:\printer.jpg” /></a>, the title “Printer Friendly” may be compared to a dictionary of keywords. If the keywords are included in the title, at 407, the processor may output the portion of the webpage source code associated with the <a> tag.

If the title does not include the keywords, at 406 the processor may compare the image alt attribute to the keywords, The alt attribute may indicate alternate language to be displayed if the image is not loaded onto the webpage. For example, for <a href=www.test.com/printerfriendly><img title=“printer image” alt=“Print” src=“printjpg” /> </a> may indicate that if the printjpg image is unable to load on the webpage, the text “Print” is displayed in place of the image. The processor may compare “Print” to the list of keywords. If the attribute value is not included in the list, the processor continues to analyze the next <a> tag. If the attribute is included in the list, at 407, the processor may output the portion of the webpage source code associated with the <a> tag.

Referring back to FIG. 3 and proceeding to 303, the processor identifies a uniform resource locator associated with the identified tag if determined that the text associated with the identified tag is related to the list of text. For example, the processor may extract the value of a href attribute value within the identified <a> tag. The processor may perform additional processing and checking on the href attribute value to determine if it includes a valid uniform resource locator. For example, the processor may determine that the href attribute includes a uniform resource locator. In some cases, the href attribute may include code to dynamically generate the uniform resource locator when the webpage is loaded or when the link is clicked. The processor may determine whether the href attribute includes a uniform resource locator by determining whether the value includes text indicative of a uniform resource locator, such as but not limited to “www”, “.co”, or “.com”. The processor may determine whether the href value includes text indicative of a dynamically generated uniform resource locator, such as “javascript” or other language indicating computer code.

The processor may identify a uniform resource locator within the href value and determine whether the uniform resource locator includes a full path or a relative path. For example, the processor may determine that a uniform resource locator beginning with “1” includes a relative path. If the processor determines that the uniform resource locator includes a relative path, the processor may append the rest of the path to the uniform resource locator. For example, the uniform resource locator may be /printerfriendly, and the webpage may be www.test.com. The processor may update the uniform resource locator for output to be www.test.com/printerfriendly.

The processor may determine whether the domain of the uniform resource locator matches the domain of the webpage. For example, if the webpage is www.test.com and the uniform resource locator is www.computer.com/printerfriendly, the processor may determine that because www.test.com and www.computer.com do not match that the uniform resource locator is likely to be invalid. The processor may look at a setting to see if the domain should be checked. Checking the domain may in some cases increase the likelihood that an identified uniform resource locator is a valid uniform resource locator of the particular type.

Additional types of processing may also be performed. The processor may perform fewer or more checks on the href value. In some cases, the processor performs more than one validation check of the uniform resource locator,

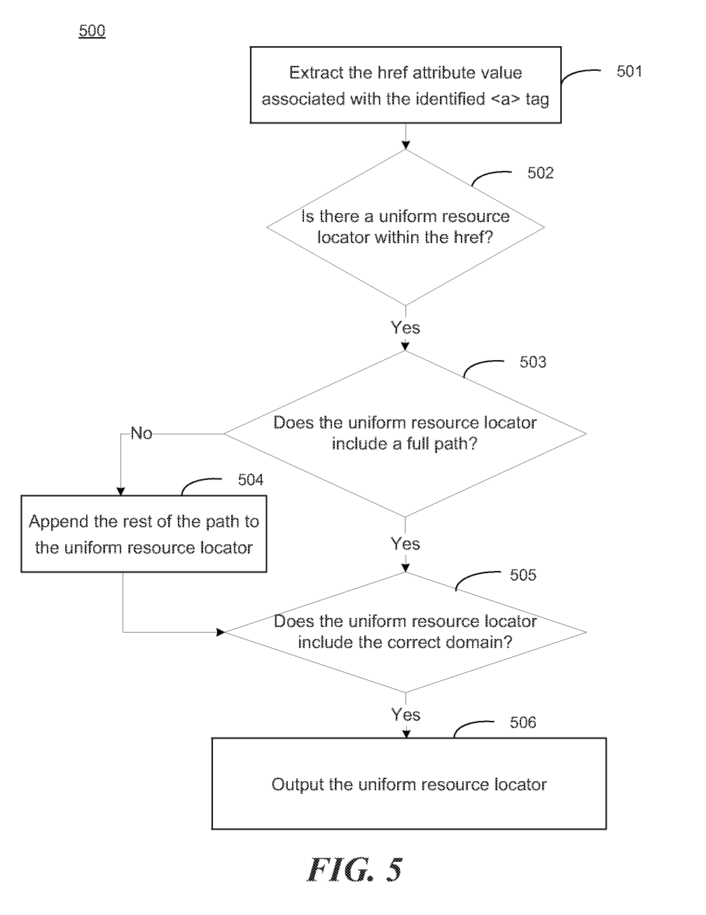

Block 303 of FIG. 3 is discussed in conjunction with FIG. 5. FIG. 5 is a flow chart 500 illustrating one example of extracting a uniform resource locator from a webpage. At 501, a processor extracts the href value within an identified tag. For example, a tag <a href=test.com>Link</a> may be identified as containing a link of a particular type, and the href value test.com may be extracted. At 502, the processor determines whether there is a uniform resource locator within the href value. For example, the href value may indicate that the uniform resource locator is dynamically generated. If the uniform resource locator is dynamically generated, the processor may use a different method to extract the uniform resource locator or may determine that the uniform resource locator may not be automatically extracted. If the processor determines that the href value includes a uniform resource value, the processor continues to check the uniform resource locator.

At 503, the processor determines whether the uniform resource locator includes a full path. For example, the href value may include a relative path. At 504, if the processor determines that the href value does not include the full path, the processor appends the rest of the path to the href value so that it contains a full path.

At 505, the processor determines whether the domain of the uniform resource locator is the same as the webpage domain. If not, the processor may determine that the uniform resource locator is invalid and not output the uniform resource locator. If the uniform resource locator is found to have the same domain, at 506, the processor outputs the uniform resource locator.

Referring back to FIG. 3 and moving to 304, the processor provides the identified uniform resource locator. The extracted uniform resource locator may be provided in any suitable manner. For example, the uniform resource locator may be stored, displayed, or transmitted. In some implementations, the processor or another processor accesses the webpage found at the uniform resource locator. The webpage may be accessed, for example, no that the webpage may be analyzed for information retrieval or archival purposes.

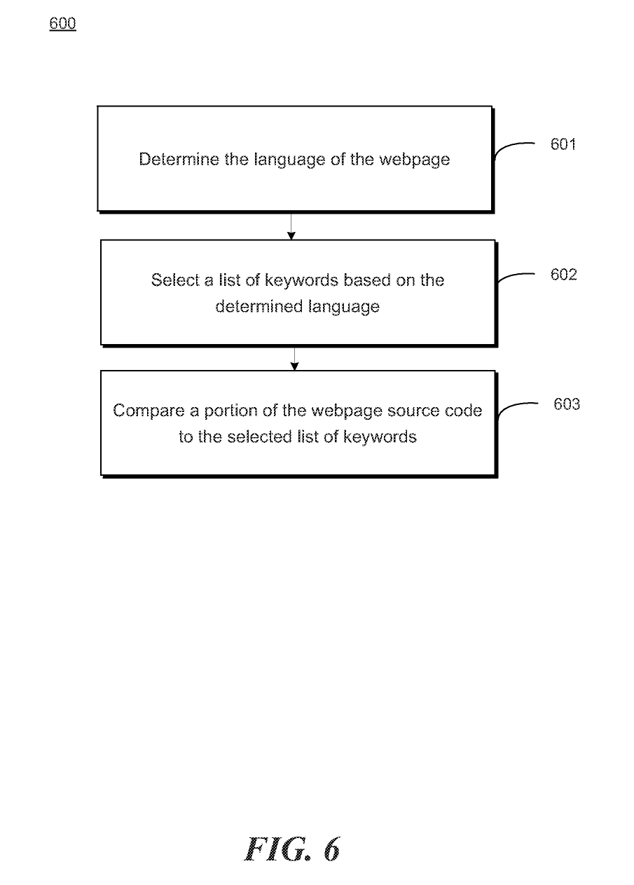

FIG. 6 is a flow chart 600 illustrating one example of method to compare a portion of a webpage to keywords related to multiple languages. For example, a different set of keywords may be compared to a portion of a webpage indicating a link depending on the language of the webpage. A set of keywords of the corresponding language may be selected and compared to the portion of the webpage. The method may be executed, for example, by the processor 102.

Beginning at 601, a processor determines the language of the webpage being analyzed. For example, the processor may analyze the webpage text or source code. In some cases, the processor may receive an indication of the webpage language from a user or other program. In one implementation, the processor looks at the Hypertext Transfer Protocol (HTTP) header of the webpage. For example, the HTTP protocol has a field for a character encoding field that some web servers may set to tell the client browser which language encoding is used in the enclosed HTML file.

Continuing to 602, the processor selects a list of keywords based on the determined language. For example, there may be multiple sets of keywords, and the processor may select the keywords associated with the determined language. Moving to 603, the processor compares a portion of the webpage source code to the selected list of keywords. For example, an <a> tag in webpage code may be located, and text or attribute values associated with the tag may be compared to the selected list of keywords to determine if the portion of the webpage includes a uniform resource locator of a particular type. The uniform resource locator may then be extracted and provided.

Identifying and extracting a uniform resource locator of a particular type within a webpage's source code based on a comparison to keywords and phrases may allow a particular type of uniform resource locator to be automatically identified and extracted. The webpage at the extracted uniform resource locator may then be automatically accessed, such as by a computer program for conducting information retrieval or information archival.

1. A method for providing a uniform resource locator, comprising:
identifying, by a processor, a tag in a webpage's source code indicating a uniform resource locator on the webpage;
determining, by a processor, whether text associated with the identified tag is related to a list of text associated with a type of uniform resource locator;
identifying, by a processor, a uniform resource locator as being associated with the identified tag if it is determined that the text associated with the identified tag is related to the list of text; and
providing, by a processor, the identified uniform resource locator,

2. The method of claim 1, wherein determining whether text associated with the identified tag is related to the list of text comprises determining whether text associated with the identified tag is related to a list of text associated with a printer friendly webpage version.

3. The method of claim 1, wherein identifying a tag comprises identifying a particular type of tag within a tree structure of tags included in the webpage's source code.

4. The method of claim 1, wherein determining whether text associated with the identified tag is related to the list of text comprises determining whether text associated with an image tag associated with the identified tag is related to the list of text.

5. The method of claim 1, wherein identifying the uniform resource locator associated with the identified tag comprises identifying a uniform resource locator related to an attribute of the identified tag.

6. The method of claim 1, further comprising processing the identified uniform resource locator, wherein processing the identified uniform resource locator comprises at least one of:
confirming that the extracted text includes a uniform resource locator with a domain consistent with the domain of the webpage; and
updating the identified uniform resource locator to form a uniform resource locator with a full directory path.

7. An electronic device, comprising:
a memory storing computer-readable instructions; and
a processor coupled to the memory, to execute the instructions, and based at least in part on the execution of the instructions, to:
identify a portion of a webpage source code associated with a type of uniform resource locator link, comprising comparing text associated with a type of tag in the webpage source code to a list of keywords associated with the type of uniform resource locator link;
extract text from the identified portion of the webpage source code indicating a uniform resource locator of the type; and
provide the extracted text.

8. The electronic device of claim 7, wherein the processor further executes instructions to validate the extracted text,
wherein validating the extracted text comprises at least one of:
confirming that the extracted text includes a uniform resource locator domain consistent with the domain of the webpage; and
updating the extracted text to form a uniform resource locator with a full directory path where the uniform resource locator includes a relative directory path.

9. The electronic device of claim 7, wherein the type of uniform resource locator comprises a uniform resource locator for a printer friendly version of the webpage.

10. A machine-readable non-transitory storage medium including instructions executable by a processor, comprising instructions to:
identify a portion of webpage source code based on a comparison of the webpage source code to a list of text associated with a type of webpage uniform resource locator; and
locate a uniform resource locator within the identified portion of the webpage source code; and
provide the located uniform resource locator.

11. The machine-readable non-transitory storage medium of claim 10, wherein the list of text comprises a list of text associated with a uniform resource locator to a printer friendly webpage version.

12. The machine-readable non-transitory storage medium of claim 10, further comprising instructions to:
determine the language of the webpage; and
select a list of text based on the determined language,
wherein instructions to identify a portion of the webpage based on the list of text comprise instructions to identify a portion of the webpage based on the selected list of text.

13. The machine-readable non-transitory storage medium of claim 10, wherein instructions to locate the uniform resource locator within the identified portion of the webpage source code comprise instructions to determine whether the identified portion includes a webpage tag attribute with a uniform resource locator.

14. The machine-readable non-transitory storage medium of claim 10, further comprising instructions to compare the domain of the located uniform resource locator to the domain of the webpage to determine if the domain of the located uniform resource locator matches the domain of the webpage, and
wherein instructions to provide the located uniform resource locator comprise instructions to provide the located uniform resource locator where determined that the domain of the located uniform resource locator matches the domain of the webpage,

15. The machine-readable non-transitory storage medium of claim 10, further comprising instructions to update the located uniform resource locator to include a full directory path when determined that the located uniform resource locator includes a relative directory path, and
wherein instructions to provide the located uniform resource locator comprise instructions to provide the updated uniform resource locator.
